(19) United States
(12) Patent Application Publication
(10) Pub. No.: US 2008/0005003 A1
(43) Pub. Date: Jan. 3, 2008

(54) Method Of Managing An Investment Fund And An Investment Fund Regarding Same

(76) Inventor: Michael G. Willis, Colorado Springs, CO (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/683,347

(22) Filed: Mar. 7, 2007

Related U.S. Application Data
(60) Provisional application No. 60/779,451, filed on Mar. 7, 2006.

(51) Int. Cl. G06Q 40/00

(52) U.S. Cl. 705/36 R

(57) ABSTRACT

A method of managing an open-ended investment fund of funds traded on a public exchange includes selecting the funds for the investment fund to include the asset classes of bonds and capital, and the asset sectors of real estate, raw materials, and energy. The asset classes and asset sectors are also weighted substantially equally to form the investment fund. Rebalancing of the selected asset classes and asset sectors occurs over time to maintain the equal weighting of the asset classes and asset sectors.

### CROSS-REFERENCE TO RELATED APPLICATION

This application claims the benefit of U.S. Provisional Application No. 60/779,451, filed Mar. 7, 2006, which is hereby incorporated herein by reference in its entirety.

### FIELD OF THE INVENTION

The present invention relates to the structure of investment portfolios and, more particularly, to using weighted asset classes and asset sectors for allocating investments in an investment fund.

### BACKGROUND OF THE INVENTION

In order to maximize return on financial investments, one investment strategy includes diversifying an investment portfolio so that the average value of the portfolio is not too adversely affected by a drop in value of the shares of any one company or one industry sector that is owned by the portfolio. Thus, for example, an investment portfolio may maintain an acceptable average value because medical companies owned by the portfolio may be retaining high values even though computer companies owned by the portfolio are doing poorly. Similarly, the portfolio may be diversified by type of investment such as bonds, stocks, money market instruments, and/or other securities.

In order to provide a convenient mechanism for diversifying an investment portfolio, collective investment funds provide ownership in securities of many different business entities. Investors buy shares of the fund and an investment entity, such as a financial institution or other brokerage, investment banking or asset management entity, manages the fund. A fund manager typically decides what specific investments to make for the fund. Examples of such funds are mutual funds, exchange-traded funds (“ETFs”), or others established under the Investment Company Act of 1940 under U.S. federal law (hereinafter “40 Act Fund”).

Each investment fund, including mutual funds, adheres to an investment policy for the fund. Most funds typically invest in a single asset classification or industry sector. Thus, for example, many funds only invest in stocks from companies of a certain capitalization size (for example, small, mid, or large-cap companies). Other funds additionally or alternatively only invest in stocks of companies with a certain financial condition such as undervalued companies or companies with high growth potential. Other collective investments only invest in a single industry sector such as computer or telecommunication companies while other examples include commodity based mutual funds and Real Estate mutual funds that only invest in real estate companies including Real Estate Investment Trusts (“REITs”). In many of these investment funds, however, unnecessarily high risk still exists because of the lack of diversification outside of the single asset classification or asset sector of the investment fund.

One known attempt at a solution is a fund of funds that is a single fund that purchases underlying mutual funds or other types of funds such as an exchange-traded fund (“ETF”). These funds of funds, however, are usually managed by a financial company that also owns, or is associated with, a whole family of “proprietary” funds. The typical fund of funds only offers these “proprietary” funds in its fund of funds. This is a problem because often times an investor is seeking funds managed by high quality fund managers no matter who employs those managers. By limiting a fund of funds to proprietary funds of a single company, the fund of funds is restricted to a team of fund managers associated with that single company regardless of the qualifications of those managers. Since no one investment entity can claim that it employs or has a monopoly on the top performing managers, limiting the investor to only those managers employed by the investment entity unnecessarily ties the hands of the investor and can limit the investor's ability to select from funds managed by the best managers.

Another disadvantage of the fund of funds, and mutual funds in general, is the primary investment strategy in the funds is typically a tactical investment strategy that requires reactions (e.g., buying or selling shares of the underlying funds) to changes in the market. Often times these reactions are ill-advised and are based on faulty research or may be good for the short term but are financially damaging to the fund as a whole in the long term.

Furthermore, while the fund of funds may provide access to a large amount of funds for the general public, the typical fund of funds is still limited to the investment classes mentioned above (size of company for example) and to certain popular industry sectors (e.g., Internet related, telecommunications, pharmaceutical, etc.). This mix of underlying funds can often reduce diversification of the portfolio by substantially overlapping investments where multiple funds invest in the same companies and/or industry sector, or where a number of the industry sectors covered by different funds will typically raise or fall in value together. Therefore, a need exists to overcome all of the shortcomings mentioned above.

### BRIEF DESCRIPTION OF THE DRAWINGS

FIG. 1 is a flow chart of the method of providing an investment fund of the present invention;

FIG. 2 is a flow chart for an alternative method of providing an investment vehicle of the present invention;

FIG. 3 is a schematic diagram of an investment fund of the present invention;

FIG. 4 is a simplified schematic diagram of a computer network of the present invention;

FIG. 5 is a flow chart for a method of investing assets of the present invention; and

FIG. 6 is a flow chart for an alternative method of investing assets of the present invention.

### DESCRIPTION OF THE PREFERRED EMBODIMENTS

In one form, the public is provided with a one-step purchase process that provides diversification to protect investments. This is accomplished by providing an investment fund that is an open-ended, fund of funds with a portfolio diversified among a number of asset classes and asset sectors. This diversification is maintained by equally balancing the asset classes and asset sectors and maintaining that equal balance regardless of, or despite, changes in the market values of the stocks or other instruments owned by the underlying funds, or the value of the underlying funds themselves.

The investment fund is open-ended, which is a less common name for a mutual fund, exchange-traded fund (ETF), and/or other fund established by the Investment Company Act of 1940. Open-ended means that at the end of each day, the investment fund issues new shares to investors and buys back shares from investors leaving the fund. In other words, the open-ended fund is a fund that is traded daily on a public exchange. Being open-ended also means that the fund can be actively managed and its portfolio actively rebalanced versus closed or non-mutual funds. In the preferred form, the underlying funds in the fund of funds also are mutual funds, ETFs, and/or other funds established by the Investment Company Act of 1940. Alternatively, the underlying funds could be in other forms such as private or non-traded funds. As a further alternative, instead of underlying funds, the investment fund could make more direct investments in bonds, stocks or other securities such as commodity investments like futures.

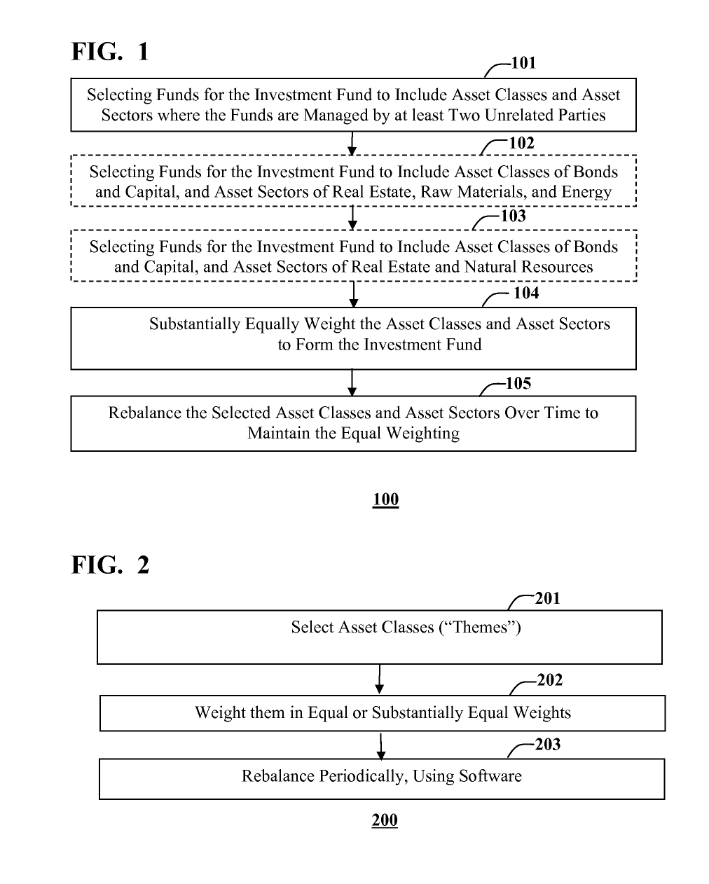

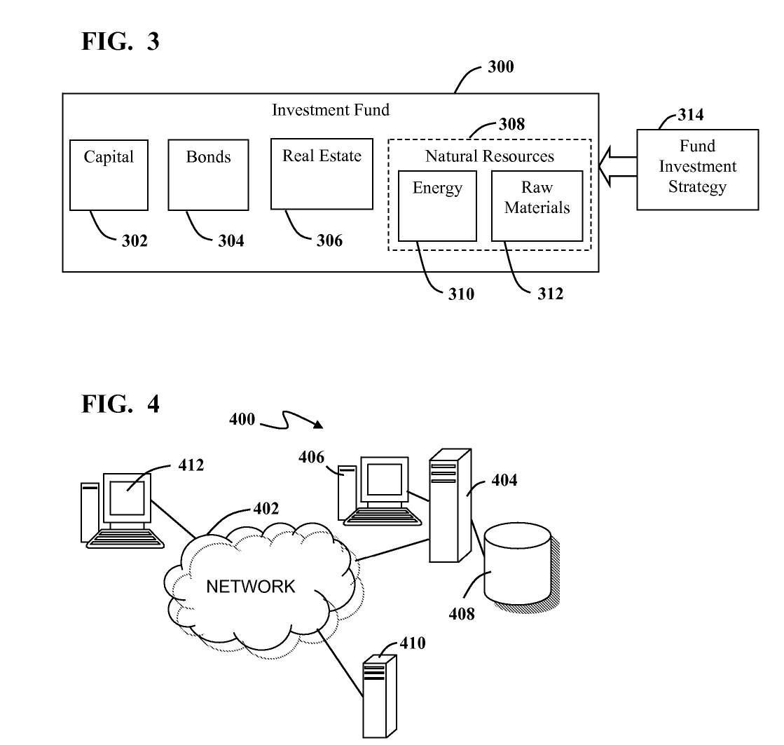

Referring to FIGS. 1 and 3, a method 100 for managing an open-ended investment fund of funds 300 is illustrated and includes selecting underlying funds 101 that provide both a number of asset classes and a number of asset sectors for the investment fund. One or more of the underlying funds may provide a single class or sector. The asset classes and asset sectors, and in turn the underlying funds, are chosen to maximize diversification. By one approach, the selected asset classes include capital markets 302 and bonds 304.

Capital markets or the capital asset class 302 refers to investment in securities in the global stock markets. This may include, but is not limited to, the New York Stock Exchange, NASDAQ, American Stock Exchange, other international stock markets, or any other stock exchange. This also may include any or all corporate capitalization sizes (large, mid, and/or small). Thus, the capital asset class 302 may or may not be limited to any one industry sector and may be provided by one or more underlying funds. Such underlying funds for this asset class may be an index fund or may have any other primary investment policy as long as it invests in stocks.

The bonds asset class 304 relates to investment in domestic and/or international fixed income securities.

The investment fund 300 also seeks underlying funds separate from the asset classes mentioned above and that provide specific asset sectors that are more likely to maintain their value despite general swings in the world markets. Thus, in one investment strategy, asset sectors are chosen that relate to main necessities for surviving in current society where the products in these sectors always have a relatively high demand no matter how the markets shift. Such sectors may relate to necessities of modem life such as shelter, food, power sources, and transportation, to name a few examples. Thus, in one example, underlying funds are selected 103 for the investment fund 300 to provide the asset sectors of real estate 306 and natural resources 308 so that a four theme or four category portfolio is established that includes: capital markets, bonds, real estate and natural resources. Alternatively, natural resources 308 may be further thought of or subdivided into the asset sectors of energy 310 and raw materials 312 to establish a five theme or five category portfolio is established that includes: capital markets, bonds, real estate, raw materials, and energy.

The real estate sector 306 may include funds that invest in securities that derive 50% or more of their revenues from companies that purchase, construct, sell, lease and/or manage real estate. Alternatively, or additionally, the investment fund 300 may directly invest in real estate or companies that are involved in real estate.

The raw materials sector 312 may include investment in funds that deal in securities that derive 50% or more of their revenues from the extraction, refinement, and distribution of raw materials. This may include products or commodities such as industrial metals, timber, food and agricultural products (such as grains, meats, and so forth), and precious metals, to name a few examples. Alternatively, the investment fund 300 may directly invest in securities of companies in this sector or directly in the commodities in this sector.

The energy sector 310 includes investment in funds that deal in securities that derive 50% or more of their revenues from the extraction, refinement, and distribution of energy or power source related products. This may include products or commodities such as oil, natural gas, unleaded gas, heating oil, alternative energies (such as power sources that relate to wind, solar energy, fuel cells, tides, hydrogen, fusion, and so forth). As with the raw materials sector, the investment fund could have a more direct investment in this sector rather than, or in addition to, investment in underlying funds.

As mentioned above, the natural resources sector may be broken down into energy and raw materials in order to form a five category portfolio. Alternatively, the category may simply be thought of as natural resources (e.g., energy and/or raw materials), thereby forming a four category portfolio. This is not to say that the four category portfolio has to include energy and raw materials as natural resources. Rather, the four category portfolio could include both energy and raw materials or, alternatively, could include simply one or the other (i.e., energy or raw materials). Furthermore, in the embodiment illustrated, the four and five category portfolios only have the four and five categories described above. However, in alternate forms, the investment fund 300 may provide more or less than the 4 or 5 categories described above and will preferably include at least three of these categories in the portfolio.

For any of the selected portfolios, in one form, the categories or the selected class assets and class sectors are permanent and do not change over time. Thus, for instance, the five category portfolio will always invest in at least, or only in, capital markets, bonds, real estate, raw materials, and energy. It should also be appreciated, that in alternate forms the investment fund could have changing or revolving investment themes or categories, if desired.

While in one form the investment fund and/or the underlying sector funds purchase stock to invest in the various asset sectors, it will be understood that the investment fund or the underlying funds may alternatively or additionally purchase other instruments such as futures, structured notes, and swaps to invest in the asset sectors if and when the federal government permits such investments. For example, under current federal law, mutual funds can have up to 10% of their portfolio invested in non-stock commodity securities. Thus, the investment fund and strategy disclosed herein could be structured to take advantage of such non-stock commodity securities if desired. It is even contemplated that some day this percentage may be higher than ten percent or that this regulation may be removed in its entirety. In such instances, the fund and strategy disclosed herein could still be used and/or applied.

In another feature of the management method 100, the underlying funds are selected to obtain high quality fund managers in the portfolio regardless of who owns or operates the underlying funds. Thus, in one example, the selected underlying funds are managed by at least two managers from unrelated or independent business entities. In another example, the selected underlying funds are managed by three or four managers from unrelated or independent business entities. In yet another example, each of the underlying funds may have a manager from a different unrelated company.

Referring again to FIGS. 1 and 3, the primary investment (or asset allocation) policy or strategy 314 of the investment fund 300 is weighting the asset classes and asset sectors substantially equally 104 to form the investment fund. The equal balance is then maintained over time regardless of the changes in the market that might suggest that the equal balance should be abandoned (such as a sector doing very poorly on the market). Thus, with this fixed asset allocation for the four category portfolio, each of the asset classes and asset sectors forms about 25% of the investment fund, and in the five category portfolio, each of the asset classes and asset sectors forms about 20% of the investment fund. Where more or less categories exist, the primary investment policy is maintained as long as each of the assets classes and asset sectors in the investment fund form a substantially equal proportion of the portfolio.

Over time, the values of each selected asset class or asset sector will fluctuate from the equally balanced proportions (such as the 20% or 25%, mentioned above for example) with the fluctuating values of the underlying funds or other investments that define the asset classes or sectors. In order to maintain the substantially equal balance of the asset sectors and asset classes, the method 100 then includes rebalancing the selected asset classes and asset sectors over time 105 to regain the substantially equal balance. It will be understood that in one form, balancing or rebalancing asset classes or asset sectors refers to shifting money obtained from investors from one asset class or sector to another asset class or sector by purchasing or selling shares of the underlying fund or funds that form that asset class or asset sector. In an alternative example, balancing may refer to the actual purchase or selling of shares or other instruments in the end-investment (e.g. stock in a company or futures in a particular commodity).

The rebalancing may be performed periodically such as once a financial quarter, once a month, once a week, and so forth. Alternatively, the time for rebalancing may be a discretionary decision of the investment fund manager. In yet another approach, the rebalancing is performed when the difference between the value of at least two of the asset classes and asset sectors reaches a predetermined maximum threshold. In one example, the threshold is a maximum difference in value between the highest value asset or sector relative to the lowest value asset or sector. For instance, if the threshold is 25% (such that the highest value asset raised in value 25% higher than the lowest asset value) and for the five category portfolio, where each category started with a value of 20 million dollars and changed in value over time so that the lowest value category is bonds which remained at 20 million and the highest value category is real estate which raised to 25 million. In this case, the threshold is reached (i.e. 25 million is 25% greater than 20 million) and the categories are all rebalanced so that each asset class and asset sector provides about 20% of the total portfolio again.

Alternatively, the threshold can be set as a percentage of the total portfolio so that when any one asset reaches a certain percentage of the portfolio, the assets are rebalanced back to equal percentages. Thus, taking the example above with 5 categories each starting with 20 million dollars for a total of 100 million dollars in the investment fund, if the threshold is 30% for instance, one of the assets would need to reach 30 million dollars to trigger the rebalancing. Regardless of which rebalancing method is used, the portfolio is rebalanced to substantially equal weights for each category and this occurs no matter how asset values are performing on any of the world markets.

With any of the configurations described above, the investment fund 300 provides an individual or company the opportunity to purchase shares of a substantially equally balanced, widely diversified portfolio. The investment fund 300, in one example, may provide individual or company accounts ranging anywhere from $2,500 to $100 million dollars or more.

Referring to FIG. 2, an alternative method 200 is provided for implementing an investment vehicle similar to investment fund 300. Thus, the method 200 includes selecting asset classes (here classes refers to both asset classes and asset sectors as described above) or themes 201 similar to selecting funds 101 for the investment fund 200. The method 200 also weights the asset classes equally or in substantially equal weights 202. The rebalancing is then performed periodically 203 and is preferably performed using software.

More specifically, and as shown on FIG. 4, the investment fund 300 may be a computer-implemented fund and may be provided or managed via a computer network 400. The network may have a vast telecommunications network 402 such as the Internet or any other WAN that is interconnected to an investment entity with a computer. In one form, the computer network includes one or more servers 404 to operate the investment fund 300. Such a server or servers 404 have a processor for at least operating software for rebalancing the assets in the asset classes and asset sectors as explained above. The server 404 may be linked to an interface or station 406 for entry of data and control of the software and a database 408 for storing investor data, financial information, programs, and/or other data necessary for operating the investment fund 300. The telecommunications network 402 may also be linked to electronically accessible exchanges 410 and/or other parties 412 that might be necessary to operate the investment fund 300 such as investors or financial institutions for convenient transfer of information and money between the investment fund operator 404 and the exchanges 410 and/or other parties 412.

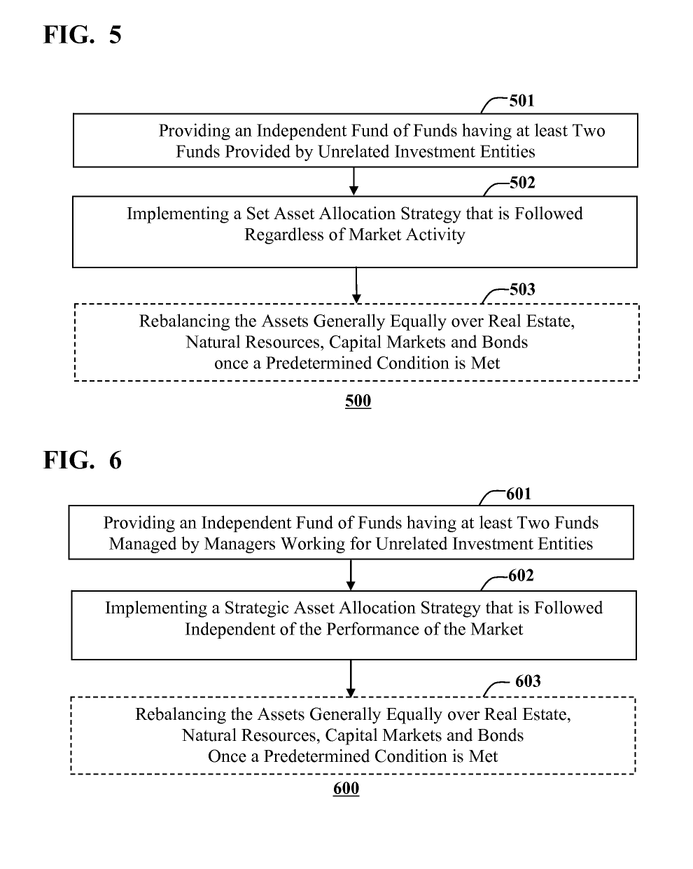

In summary, and as shown on FIG. 5, a method of investing in assets in a publicly traded market 500 provides the independent fund of funds 300 with at least two funds provided by unrelated investment entities 501. The method 500 also includes implementing a set asset allocation strategy 314 that is followed regardless of what the market is doing 502. The set asset allocation strategy is a strategic asset allocation strategy such that implementing the strategic asset allocation strategy comprises generally equally balancing the assets over Real Estate, natural resources (e.g., energy and/or raw materials), capital markets and bonds. The assets are rebalanced generally equally over Real Estate, natural resources, capital markets and bonds once a predetermined condition is met 503 such as when the assets are not balanced generally equally over Real Estate, natural resources, capital markets and bonds.

Alternatively, the predetermined condition is met when a predetermined percentage increase in at least one asset or a predetermined percentage decrease in at least one asset occurs such that the assets are not balanced generally equally over Real Estate, natural resources, capital markets and bonds. In this case, rebalancing comprises rebalancing the assets after such a predetermined percentage increase or decrease so that the assets are generally equally balanced as mentioned above. In one example, the predetermined percentage increase or decrease is between nine percent and eighty percent and rebalancing comprises rebalancing the assets after such a predetermined percentage increase or decrease so that the assets are generally equally balanced as mentioned above. As some specific examples, the predetermined percentage increase or decrease may be fourteen percent, twenty-seven percent or seventy-eight percent and rebalancing comprises rebalancing the assets after such a predetermined percentage increase or decrease.

As to the specific asset sectors, the natural resources include energy and raw materials, and balancing comprises generally balancing the assets equally over Real Estate, energy or raw materials, capital markets, and bonds. The balancing may also comprise generally balancing the assets equally over Real Estate, energy, raw materials, capital markets, and bonds.

Referring to FIG. 6, another alternative method of investing in assets in a publicly traded market 600 includes providing an independent fund of funds 300 having at least two funds managed by managers working for unrelated investment entities 601 and implementing a strategic asset allocation strategy 314 that is followed independent of the performance of the market 602. The strategic asset allocation strategy comprises investing in essential themes of life rather than traditional asset allocation schemes that depend on market performance. By one approach, this includes investing in assets related to Real Estate, natural resources, capital markets and bonds. The strategic asset allocation strategy then comprises generally equally balancing assets over Real Estate, natural resources, capital markets, and bonds such that the assets are generally equally balanced over the essential themes of life.

While the specification illustrates and describes particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A method of managing an open-ended investment fund of funds traded on a public exchange, comprising:
selecting the funds for the investment fund to include asset classes of bonds and capital markets and asset sectors of real estate, raw materials, and energy, wherein the funds are managed by at least two unrelated parties;
weighting the asset classes and asset sectors substantially equally to form the investment fund; and
rebalancing the selected asset classes and asset sectors over time to maintain the equal weighting of the asset classes and asset sectors.

2. The method of claim 1 wherein the investment fund is a 40 Act fund.

3. The method of claim 2 wherein the investment fund is a mutual fund or an exchange-traded fund (ETF).

4. The method of claim 1 wherein the capital asset class includes at least one fund that does not limit assets to any one sector.

5. The method of claim 1 wherein the asset sectors are invested by purchasing at least one of stocks, futures, structured notes, and swaps.

6. The method of claim 1 wherein the asset classes only include bonds and capital, and the asset sectors only include the sectors of real estate, raw materials, and energy.

7. The method of claim 1 wherein each of the funds in the investment fund is managed by an independent party relative to any other party managing one of the funds.

8. The method of claim 1 wherein rebalancing the asset classes and asset sectors comprises rebalancing the asset classes and the asset sectors back to the substantially equal weighting when the difference between the value of at least two of the asset classes and asset sectors reaches a predetermined threshold.

9. The method of claim 1 wherein rebalancing the assets to the substantially equally weighting of the asset classes and asset sectors occurs regardless of market activity.

10. The method of claim 1 wherein the rebalancing is performed at the discretion of a manager managing the investment fund.

11. The method of claim 1 wherein at least the rebalancing is performed by a computer.

12. The method of claim 1 wherein the asset classes and the asset sectors do not change categories over time.

13. A method of managing an open-ended investment fund of funds traded on a public exchange, comprising:
selecting the funds for the investment fund to include asset classes of bonds and capital and asset sectors of real estate and natural resources, wherein the funds are managed by at least two unrelated parties;
weighting the asset classes and asset sectors substantially equally to form the investment fund; and
rebalancing the selected asset classes and asset sectors over time to maintain the equal weighting of the asset classes and asset sectors.

14. The method of claim 13 wherein the investment fund is a 40 Act fund.

15. The method of claim 13 wherein the investment fund is a mutual fund or an exchange-traded fund (ETF).

16. The method of claim 13 wherein the capital asset class includes at least one fund that does not limit assets to any one asset sector.

17. The method of claim 13 wherein the asset sectors are invested by purchasing at least one of stocks, futures, structured notes, and swaps.

18. The method of claim 13 wherein the asset classes only include bonds and capital, and the asset sectors only include the sectors of real estate and natural resources.

19. The method of claim 13 wherein the asset sector of natural resources includes the sub-sectors of energy and raw materials.

20. The method of claim 13 wherein the asset sectors and asset classes do not change category over time.

21. The method of claim 13 wherein each of the funds in the investment fund is managed by an independent party unrelated to any other party managing one of the funds.

22. The method of claim 13 wherein rebalancing the asset classes and asset sectors comprises rebalancing the asset classes and the asset sectors back to the substantially equal weighting when the difference between the value of at least two of the asset classes and asset sectors reaches a predetermined threshold.

23. The method of claim 13 wherein rebalancing the assets to the substantially equally weighting of the asset classes and asset sectors occurs regardless of market activity.

24. The method of claim 13 wherein the rebalancing is performed at the discretion of a manager managing the investment fund.

25. The method of claim 13 wherein at least the rebalancing is performed by a computer.

26. A method of managing an open-ended investment fund of funds traded on a public exchange, comprising:
selecting the funds for the investment fund to include the asset classes of bonds and capital and at least two asset sectors wherein the selected funds are managed by a plurality of independent business entities;
weighting the asset classes and asset sectors substantially equally to form the investment fund; and
rebalancing the selected asset classes and asset sectors over time to maintain the equal weighting of the asset classes and asset sectors.

27. The method of claim 26 wherein the asset sectors are at least one of:
(a) real estate, raw materials, and energy, and
(b) real estate and natural resources.

28. A method of managing an open-ended investment fund of funds traded on a public exchange, comprising:
selecting the funds for the investment fund that establish asset classes of bonds and capital and at least two asset sectors relating to product categories of shelter, food, a power source, and transportation, wherein the funds are managed by at least two unrelated parties;
weighting the asset classes and asset sectors substantially equally to form the investment fund; and
rebalancing the selected asset classes and asset sectors over time to maintain the equal weighting of the asset classes and asset sectors.

29. An investment strategy for an open-ended investment fund of funds traded on a public exchange, comprising:
selected funds for the investment fund including asset classes of bonds and capital and asset sectors of real estate, raw materials, and energy, wherein the asset classes and asset sectors are substantially equally weighted over time and are managed by at least two unrelated parties, and wherein the categories of the asset classes and asset sectors do not change over time.

30. A computer-implemented open-ended investment fund of funds traded on a public exchange, comprising:
selected funds for the investment fund including asset classes of bonds and capital and asset sectors of real estate, raw materials, and energy, wherein the asset classes and asset sectors are substantially equally weighted over time and are managed by at least two unrelated parties; and
a computer for rebalancing the selected asset classes and asset sectors over time to maintain the equal weighting of the asset classes and asset sectors.

31. The investment fund of claim 29 wherein the asset class and asset sector categories do not change over time.

32. A method of investing in assets in a publicly traded market comprising:
providing an independent fund of funds having at least two funds provided by unrelated investment entities; and
implementing a set asset allocation strategy that is followed regardless of market activity.

33. The method of claim 32 wherein the set asset allocation strategy is a strategic asset allocation strategy and implementing the strategic asset allocation strategy comprises generally equally balancing the assets over Real Estate, natural resources, capital markets and bonds.

34. The method of claim 33 further comprising rebalancing the assets generally equally over Real Estate, natural resources, capital markets and bonds once a predetermined condition is met.

35. The method of claim 34 wherein the predetermined condition is met when the assets are not balanced generally equally over Real Estate, natural resources, capital markets and bonds and rebalancing comprises rebalancing the assets generally equally over Real Estate, natural resources, capital markets and bonds.

36. The method of claim 34 wherein the predetermined condition is met when a predetermined percentage increase in at least one asset or a predetermined percentage decrease in at least one asset occurs such that the assets are not balanced generally equally over Real Estate, natural resources, capital markets and bonds and rebalancing comprises rebalancing the assets after such a predetermined percentage increase or decrease so that the assets are generally equally balanced over Real Estate, natural resources, capital markets and bonds.

37. The method of claim 36 wherein the predetermined percentage increase or decrease is between nine percent and eighty percent and rebalancing comprises rebalancing the assets after such a predetermined percentage increase or decrease so that the assets are generally equally balanced over Real Estate, natural resources, capital markets and bonds.

38. The method of claim 37 wherein the predetermined percentage increase or decrease is fourteen percent, twenty-seven percent or seventy-eight percent and rebalancing comprises rebalancing the assets after such a predetermined percentage increase or decrease so that the assets are generally equally balanced over Real Estate, natural resources, capital markets and bonds.

39. The method of claim 33 wherein natural resources includes energy and raw materials and balancing comprises generally balancing the assets equally over Real Estate, energy or raw materials, capital markets and bonds.

40. The method of claim 39 wherein balancing comprises generally balancing the assets equally over Real Estate, energy, raw materials, capital markets and bonds.

41. A method of investing in assets in a publicly traded market comprising:
providing an independent fund of funds having at least two funds managed by managers working for unrelated investment entities; and
implementing a strategic asset allocation strategy that is followed independent of the performance of the market.

42. The method of claim 41 wherein the strategic asset allocation strategy comprises investing in essential themes of life rather than traditional asset allocation schemes that depend on market performance.

43. The method of claim 42 wherein the essential themes of life comprise assets related to Real Estate, natural resources, capital markets and bonds.

44. The method of claim 43 wherein the strategic asset allocation strategy comprises generally balancing assets over Real Estate, natural resources, capital markets and bonds such that the assets are generally equally balanced over the essential themes of life.

45. The method of claim 44 further comprising rebalancing the assets generally equally over Real Estate, natural resources, capital markets and bonds once a predetermined condition is met.
